(19) United States
(12) Patent Application Publication
(10) Pub. No.: US 2023/0159369 A1
(43) Pub. Date: May 25, 2023

(54) DESIGN OF APPARATUS FOR TEMPERING CURVED GLASS SHEETS

(71) Applicant: Pilkington Group Limited, Nr. Ormskirk Lancashire (GB)

(72) Inventors: Cinzia TOMASO, Chieti (IT); Michele VARALLI, Chieti (IT)

(73) Assignee: Pilkington Group Limited, Nr. Ormskirk Lancashire (GB)

(21) Appl. No.: 17/919,058

(22) PCT Filed: Apr. 16, 2021
(86) PCT No.: PCT/GB2021/050912

§ 371 Date: Oct. 14, 2022

(30) Foreign Application Priority Data
Apr. 16, 2020 (EP) 20425013.8

(51) Int. Cl. C03B 27/044; C03B 27/04; G06F 30/13

(52) U.S. Cl. CPC C03B 27/0447; C03B 27/0408; G06F 30/13

(57) ABSTRACT

A method for designing a quench box having first and second blastheads for tempering at least first, second and third sheets of glass each having a different shape is disclosed. The method comprises (i) using the shape of at least the first and second sheets of glass to calculate a first average surface; (ii) using the first average surface to calculate a quench surface of first and second quench modules of the first blasthead; (iii) using the first average surface to calculate a quench surface of a first quench module of the second blasthead; and (iv) using the shape of at least the third sheet of glass to calculate a quench surface of a quench module that replaces a quench module of the first and second blastheads when used to temper the third sheet of glass.

The present invention relates to a method for designing an apparatus for tempering hot shaped glass sheets, in particular to a method for designing an adjustable quench box for tempering hot glass sheets having different shapes or curvature.

In the manufacture of tempered shaped glass sheets, the glass sheets are normally heated to their heat softened temperature, shaped by one of a variety of well-known forming operations and cooled to impart at least a partial temper in the glass sheet. In the quenching operation, large quantities of cooling fluid, such as air, are directed at the major surfaces of the hot shaped glass sheet to rapidly lower its temperature below its strain point and establish a stress gradient through the glass sheet thickness. The outer major surfaces of the glass sheet form a compression layer while the centre of the glass sheet forms a tension layer.

Quench stations generally include upper and lower sets of opposing nozzles. The sets of nozzles are spaced at a predetermined distance apart to allow a shaped glass sheet to be positioned therebetween. To achieve uniform tempering, the transverse profile of the sets of nozzles its contoured to approximate the transverse profile of the shaped glass sheet positioned between the nozzles. Consequently, in general different upper and lower nozzle sets are required each time a shaped glass sheet with a different curvature profile is quenched. This in turn results in delays due to set-up times as well as additional tooling and associated maintenance costs. To partially offset these additional costs, the nozzle profile in the quench station may be contoured to assume an average position that allows several different curved glass sheets to be quenched with the same quench nozzle arrangement. Although such an arrangement reduces tooling and maintenance costs, the nozzles will be at varying distances from the major surface of the glass sheets and may result in non-uniform tempering.

A solution to this problem was provided in EP0249161B1 where an adjustable quench for tempering hot glass sheets of varying transverse configuration was described. The quench has overlapping members that seal a flexible nozzle assembly as it changes configurations. Nozzles extend from the flexible nozzle assembly towards the shaped glass sheet to be cooled such that the quenching surface formed by the head portions of the nozzles are generally parallel to the major surfaces of the shaped glass sheet. Each individual flexible nozzle assembly is connected to a common drive that can simultaneously flex all the nozzle assemblies.

Such an apparatus is complex to manufacture and has movable parts that are exposed to high temperatures. Such apparatus may be expensive to manufacture and maintain

Apparatus for bending and tempering heat-softened glass sheets is described in U.S. Pat. No. 4,028,086 where upper and lower blastheads are used in a tempering section. Each blasthead comprises a plenum chamber formed by an enclosure and provided with an air inlet at one end thereof and a series of modules or projecting sections at the other end thereof carrying a plurality of downwardly and upwardly directed tubes through which chilling air under pressure is directed against the opposite surfaces of the glass sheets as they are carried therebetween. The sections may be detachably secured to the plenum chamber enclosure for selective removal and/or replacement whereby one or more sections can be readily replaced, when necessary, without disturbing the remaining sections.

Quenching apparatus for tempering curved glass plates is described in U.S. Pat. No. 4,343,645 and GB1512548. An adjustable quench for tempering a glass sheet is described in U.S. Pat. No. 4,711,655. Tempering glass sheets is described in U.S. Pat. No. 4,142,882 and GB625,069. Methods and apparatus for adjusting the quench head of glass tempering is described in U.S. Pat. No. 5,846,281.

The present invention provides a method for designing a blasthead that may be used to temper multiple glass parts having different degrees of curvature that at least partially overcomes the problems identified above.

Accordingly, the present invention provides a method for designing a quench box for tempering at least first, second and third sheets of glass each having a different shape, the quench box comprising a first blasthead and a second blasthead spaced apart therefrom, the first blasthead being opposite the second blasthead and each of the first and second blastheads being configured to direct jets of cooling fluid towards a conveyance plane for conveying a sheet of glass thereon, the conveyance plane having a first axis and a second axis, the first axis defining a direction of conveyance for a glass sheet along the conveyance plane and the second axis being perpendicular to first axis; the quench box having a first configuration for tempering the first and second sheets of glass and a second different configuration for tempering the third sheet of glass; wherein in the first configuration, the first blasthead of the quench box comprises at least a first quench module and a second quench module, and the second blasthead of the quench box comprises at least a first quench module, each quench module comprising a respective array of quench nozzles defining a respective quench surface; further wherein when the quench box is in the second configuration, at least one of the quench modules of the first and second blastheads has been replaced with a different quench module, the or each different quench module comprising a respective array of quench nozzles defining a respective quench surface; the method comprising the steps (i) using the shape of at least the first and second sheets of glass to calculate a first average surface, the first average surface being an approximation of the shape of the at least first and second sheets of glass; (ii) using the first average surface to calculate the respective quench surface of the first and second quench modules of the first blasthead so that in the first configuration the first and second quench modules of the first blasthead are arranged so that the quench surfaces thereof are at least partially alignable with at least a portion of the first average surface; (iii) using the first average surface to calculate the quench surface of the first quench module of the second blasthead so that in the first configuration the first quench module of the second blasthead is arranged so that the quench surface thereof is at least a partially alignable with at least a portion of the first average surface; and (iv) using the shape of at least the third sheet of glass to calculate the quench surface of the or each different quench module, so that that in the second configuration the quench modules of the first and second blastheads are arranged so that the quench surfaces thereof approximate the shape of the third sheet of glass.

Preferably the first average surface comprises a geometric average or an arithmetic average or a weighted average or a least squares fit of the shapes of the at least first and second sheets of glass.

Preferably the first average surface is calculated by (a) determining for each of the at least first and second sheets of glass a plane mid-way between opposing major surfaces of each respective glass sheet, each plane having a centreline arranged to be parallel to the first axis; (b) arranging each plane determined in step (a) such that the centrelines thereof are coincident and lie on a horizontal plane; (c) for a given point on the horizontal plane, extending a line normal to the horizontal plane through the given point to intersect each plane of the at least first and second sheets of glass at a respective intersection point; and (d) using each intersection point to determine an average intersection point for the at least first and second sheets of glass at the given point, the average intersection point being a first average distance from the horizontal plane. Using this approach, the first average surface may be calculated at a plurality of points relative to the horizontal plane.

Preferably in step (ii) the first and second quench modules of the first blasthead are arranged so that the quench surfaces thereof are alignable with the first average surface.

Preferably in step (iii) the first quench module of the second blasthead is arranged so that the quench surface thereof is alignable with the first average surface.

The first and second blastheads are spaced apart sufficiently to allow the glass sheet to be tempered to pass therebetween. The nozzles and pressure of cooling fluid through said nozzles may be adjusted to allow the separation of the first and second blastheads to be altered.

Typically, the first and second blastheads may be moved apart, a glass sheet to be tempered positioned therebetween, and the first and second blastheads are then moved towards each other to temper the glass sheet.

Also as is known in the art, it is conventional that when the glass sheet to be tempered is between the first and second blastheads, the glass sheet may be oscillated backwards and forwards along the conveyance plane to assist with the tempering process.

In the first configuration the first and second blast heads of the quench box are spaced apart by a first spacing.

In the second configuration the first and second blast heads of the quench box are spaced apart by a second spacing.

Preferably the spacing of the first and second blastheads in the first and second configurations of the quench box is the same. That is, it is preferred that the first spacing is the same as the second spacing.

Each quench module has an array of quench nozzles that defines a quench surface for the respective quench module. The nozzles have an entrance end and an exit end from which the cooling fluid emerges. The exit ends of the nozzles lie in the quench surface and the quench surface lies a predetermined distance away from the major surface of the glass sheet to be cooled. The nozzles may be tubes, holes formed in a solid bar or strip, or any other configuration known in the art.

The predetermined distance that the quench surface lies away from the major surface to be cooled may be determined by routine experimentation. For example, for a given quench box having a certain number of nozzles in the first and second blastheads, keeping all other tempering conditions the same, the effect of the spacing of the blastheads on the degree of temper may be assessed. Beyond a certain spacing, it will not be possible to adequately temper the glass sheet (unless some other process parameter is changed), for example the tempered glass sheet will not pass the required test, such as a fragmentation test as specified in ECE R43.

The predetermined distance may provide optimum tempering performance and is the spacing of the quench surfaces away from the major surfaces of the glass sheet to be tempered. Either side of the predetermined distance is a tempering region where the quench surfaces may be positioned such that the glass sheet may be tempered to an acceptable level.

In general, for curved glass sheets having similar shapes, the predetermined distance and the tempering region are essentially the same for each glass sheet.

The first and second blastheads are also spaced apart from the conveyance plane.

Preferably the first blasthead is spaced apart from the conveyance plane by at least a first separation.

Preferably the second blasthead is spaced apart from the conveyance plane by at least a second separation.

Preferably the first separation of the first blasthead from the conveyance is the same as the second separation of the second blasthead from the conveyance plane.

Preferably when the quench box is in the second configuration, at least one of the first and second quench modules of the first blasthead is replaced by a different quench module, the or each different quench module comprising a respective array of quench nozzles defining a quench surface.

Preferably when the quench box is in the second configuration, the first quench module of the second blasthead is replaced by a different quench module, the different quench module comprising a respective array of quench nozzles defining a quench surface.

In some embodiments the second blasthead comprises a second quench module comprising a respective array of quench nozzles defining a quench surface, and wherein the method includes a step of using the first average surface to calculate the quench surface of the second quench module of the second blasthead so that in the first configuration the first and second quench modules of the second blasthead are arranged so that the quench surfaces thereof are at least partially alignable with at least a portion of the first average surface.

Preferably the step of using the first average surface to calculate the quench surface of the second quench module of the second blasthead takes place during step (iii).

Preferably when the quench box is in the second configuration, at least one of the first and second quench modules of the first blasthead has been replaced by a respective different quench module, the or each different quench module comprising a respective array of quench nozzles defining a quench surface.

Preferably when the quench box is in the second configuration, at least one of the first and second quench modules of the second blasthead has been replaced by a respective different quench module, the or each different quench module comprising a respective array of quench nozzles defining a quench surface.

Preferably the quench surface of the first quench module of the first blast head is parallel to the quench surface of the first quench module of the second blasthead.

Preferably the quench surface of the second quench module of the first blast head is parallel to the quench surface of the second quench module of the second blasthead.

Preferably the quench surface of the first quench module of the first blasthead is vertically aligned with the quench surface of the first quench module of the second blasthead.

Preferably the quench surface of the second quench module of the first blasthead is vertically aligned with the quench surface of the second quench module of the second blasthead.

In some embodiments the first blasthead comprises a third quench module comprising a respective array of quench nozzles defining a quench surface, and wherein the method includes a step of using the first average surface to calculate the quench surface of the third quench module of the first blasthead, so that in the first configuration the first, second and third quench modules of the first blasthead are arranged so that the quench surfaces thereof are at least partially alignable with at least a portion of the first average surface.

Preferably the step of using the first average surface to calculate the quench surface of the third quench module of the first blasthead takes place during step (ii).

Preferably in step (ii) the first, second and third quench modules of the first blasthead are arranged so that the quench surfaces thereof are alignable the first average surface.

Preferably in step (iii) the first quench module of the second blasthead is arranged so that the quench surface thereof is alignable with the first average surface.

Preferably when the quench box is in the second configuration, at least one of the first, second and third quench modules of the first blasthead has been replaced by a respective different quench module, the or each different quench module comprising a respective array of quench nozzles defining a quench surface.

It is also preferred that the second blasthead comprises a second quench module comprising an array of quench nozzles defining a quench surface, and wherein the method includes a step of using the first average surface to calculate the quench surface of the second quench module of the second blasthead so that in the first configuration the first and second quench modules of the second blasthead are arranged so that the quench surfaces thereof are at least partially alignable with at least a portion of the first average surface, and when the quench box is in in the second configuration at least one of the first and second quench modules of the second blasthead has been replaced by a respective different quench module, the or each different quench module comprising a respective array of quench nozzles defining a quench surface.

In some embodiments the second blasthead comprises a second quench module and a third quench module, each of the second and third quench modules comprising a respective array of quench nozzles defining a respective quench surface, and the method includes a step of using the first average surface to calculate the quench surface of the second and third quench modules of the second blasthead so that in the first configuration the first, second and third quench modules of the second blasthead are arranged so that the quench surfaces thereof are at least partially alignable with at least a portion of the first average surface.

Preferably the step of using the first average surface of the first and second sheets of glass to calculate the quench surface of the second and third quench modules of the second blasthead takes place during step (iii).

Preferably in step (iii) the first, second and third quench modules of the second blasthead are arranged so that the quench surfaces thereof is alignable with the first average surface.

Preferably when the quench box is in the second configuration, at least one of the quench modules of the first blasthead is replaced by a different quench module, the or each different quench module comprising a respective array of quench nozzles defining a quench surface.

Preferably when the quench box is in the second configuration, at least one of the first, second or third quench modules of the second blasthead is replaced by a different quench module, the or each different quench module comprising a respective array of quench nozzles defining a quench surface.

In some embodiments the first blasthead comprises a third quench module and a fourth quench module each comprising a respective array of quench nozzles defining a respective quench surface, and wherein the method includes a step of using the first average surface to calculate the quench surface of the third and fourth quench modules of the first blasthead so that in the first configuration the first, second, third and fourth quench modules of the first blasthead are at least partially alignable with at least a portion of the first average surface.

Preferably the step of using the first average surface to calculate the quench surface of the third and fourth quench modules of the first blasthead takes place during step (ii).

Preferably in step (ii) the first, second, third and fourth quench modules of the first blasthead are arranged so that the quench surfaces thereof are alignable the first average surface.

Preferably when the quench box is in the second configuration, at least one of the first, second, third or fourth quench modules of the first blasthead is replaced by a different quench module, the or each different quench module comprising a respective array of quench nozzles defining a quench surface.

Preferably when the quench box is in the second configuration, at least one of the quench modules of the second blasthead is replaced by a different quench module, the or each different quench module comprising a respective array of quench nozzles defining a quench surface.

In some embodiments the second blasthead comprises a second quench module, a third quench module and a fourth quench module, each comprising a respective array of quench nozzles defining a respective quench surface, and the method includes a step of using the first average surface to calculate the quench surface of the second, third and fourth quench modules of the second blasthead so that in the first configuration the first, second, third and fourth quench modules of the second blasthead are arranged so that the quench surfaces thereof are at least partially alignable with at least a portion of the first average surface.

Preferably the step of using the first average surface to calculate the quench surface of the second, third and fourth quench modules of the second blasthead takes place during step (iii).

Preferably in step (iii) the first, second, third and fourth quench modules of the second blasthead are arranged so that the quench surfaces thereof are alignable with the first average surface.

Preferably when the quench box is in the second configuration, at least one of the quench modules of the first blasthead is replaced by a different quench module, the or each different quench module comprising a respective array of quench nozzles defining a quench surface.

Preferably when the quench box is in the second configuration, at least one of the first, second, third or fourth quench modules of the second blasthead is replaced by a different quench module, the or each different quench module comprising a respective array of quench nozzles defining a quench surface.

Embodiments of the first aspect of the present invention have other preferable features.

Preferably the second axis lies in the conveyance plane.

Preferably the first quench module of the first blasthead comprises two or more nozzles arranged in a line, more preferably in a line running parallel to the first axis or the second axis

Preferably the first quench module of the first blasthead comprises two or more rows of nozzles running parallel to the first axis or second axis.

Preferably the first quench module of the second blasthead comprises two or more nozzles arranged in a line, more preferably in a line running parallel to the first axis or the second axis.

Preferably the first quench module of the second blasthead comprises two or more rows of nozzles running parallel to the first axis or the second axis.

Preferably the first quench module of the first blasthead comprises between four and eight rows of nozzles, more preferably eight rows of nozzles, at least one of which runs parallel to the first axis or the second axis.

Preferably the first quench module of the second blasthead comprises between four and eight rows of nozzles, more preferably eight rows of nozzles, at least one of which runs parallel to the first axis or the second axis.

Preferably the first quench module of the first blasthead and/or the first quench module of the second blasthead comprises less than fifty rows of nozzles, more preferably less than forty rows of nozzles, even more preferably less than thirty rows of nozzles, even more preferably less than twenty rows of nozzles.

When the first blasthead comprises at least one different quench module, preferably the or each different quench module of the first blasthead comprises two or more rows of nozzles, preferably between four and eight rows of nozzles, even more preferably eight rows of nozzles. Preferably at least one of the rows of nozzles of the or each different quench module of the first blasthead runs parallel to the first axis or the second axis.

When the second blasthead comprises at least one different quench module, preferably the or each different quench module of the second blasthead comprises two or more roes of nozzles, preferably between four and eight rows of nozzles, even more preferably eight rows of nozzles. Preferably at least one of the rows of nozzles of the or each different quench module of the second blasthead runs parallel to the first axis or the second axis.

Preferably each quench module of the first blasthead comprises between two and ten rows of nozzles, more preferably eight rows of nozzles, at least one of which runs parallel to the first axis or the second axis.

Preferably each quench module of the second blasthead comprises between two and ten rows of nozzles, more preferably eight rows of nozzles, at least one of which runs parallel to the first axis or the second axis.

Preferably the first average surface is calculated using at least one other sheet of glass having a respective shape.

Preferably the first average surface is calculated using less than 100 sheets of glass each having a different respective shape.

Preferably in step (iv) the shape of the third sheet of glass and at least one other sheet of glass having a different shape are used to calculate a second average surface, the second average surface being an approximation of the shape of the third sheet of glass and the at least one other sheet of glass; and wherein the second average surface is used to calculate the quench surface of the or each different quench module, so that that in the second configuration the quench modules are arranged so that the quench surfaces thereof are at least partially alignable with at least a portion of the second average surface. In such embodiments it is preferred that in in the second configuration the quench modules are arranged so that the quench surfaces thereof are alignable with the second average surface.

The present invention will now be described with reference to the following figures (not to scale) in which:

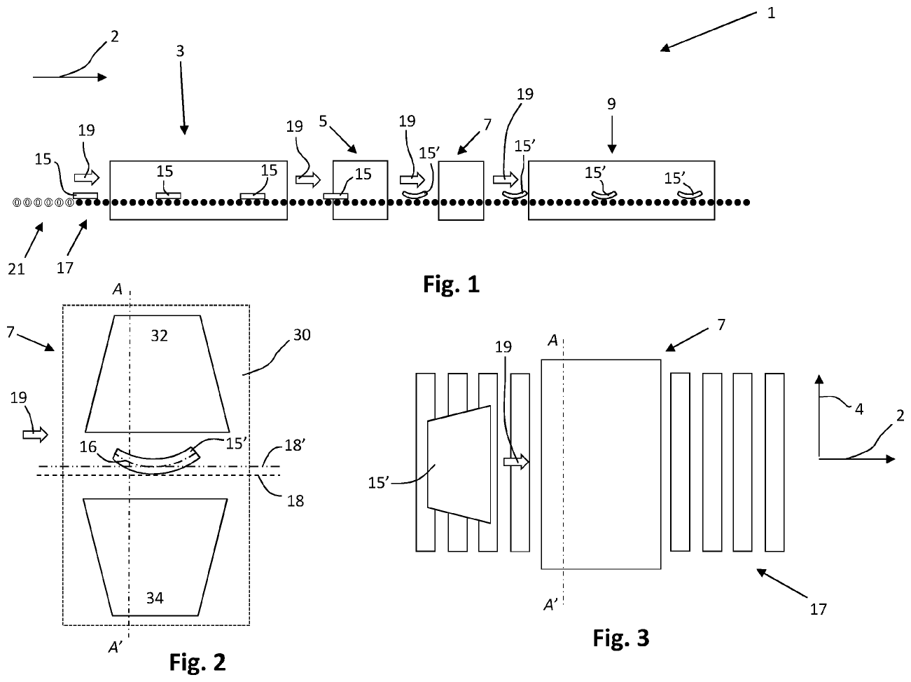

FIG. 1 is a schematic side-view representation of a production line for making a glazing panel;

FIG. 2 is a schematic side-view representation of the tempering section of the production line of FIG. 1;

FIG. 3 is a schematic plan view of a portion of the production line of FIG. 1;

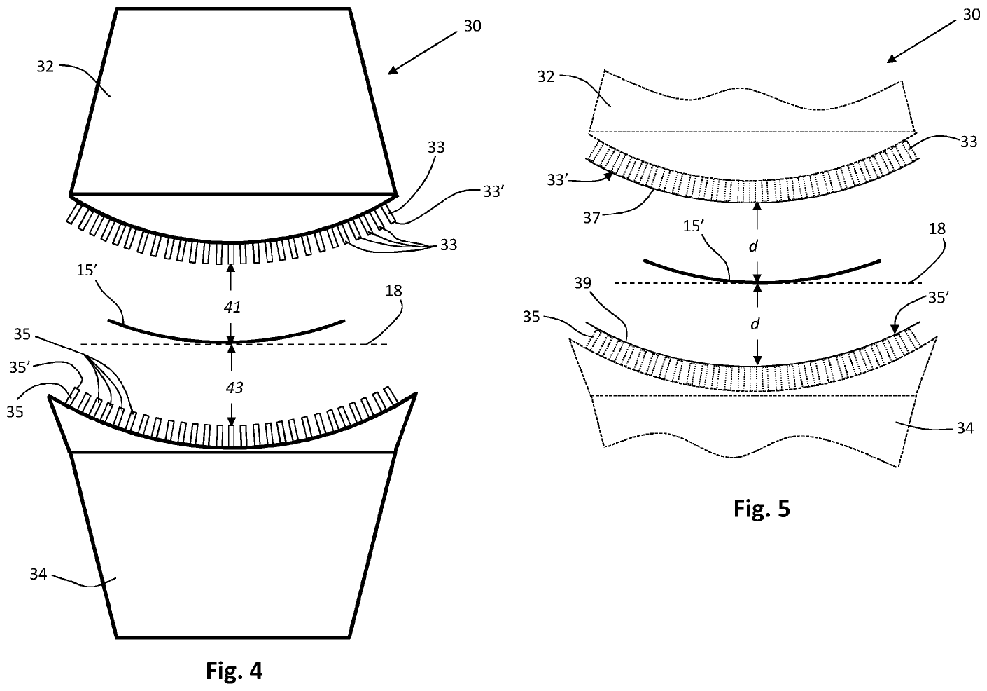

FIG. 4 is a schematic side view representation of a pair of blastheads for use in a tempering section of a production line;

FIG. 5 is a schematic side-view representation of a portion of the blastheads shown in FIG. 4 to illustrate the quench surfaces of the upper and lower blastheads;

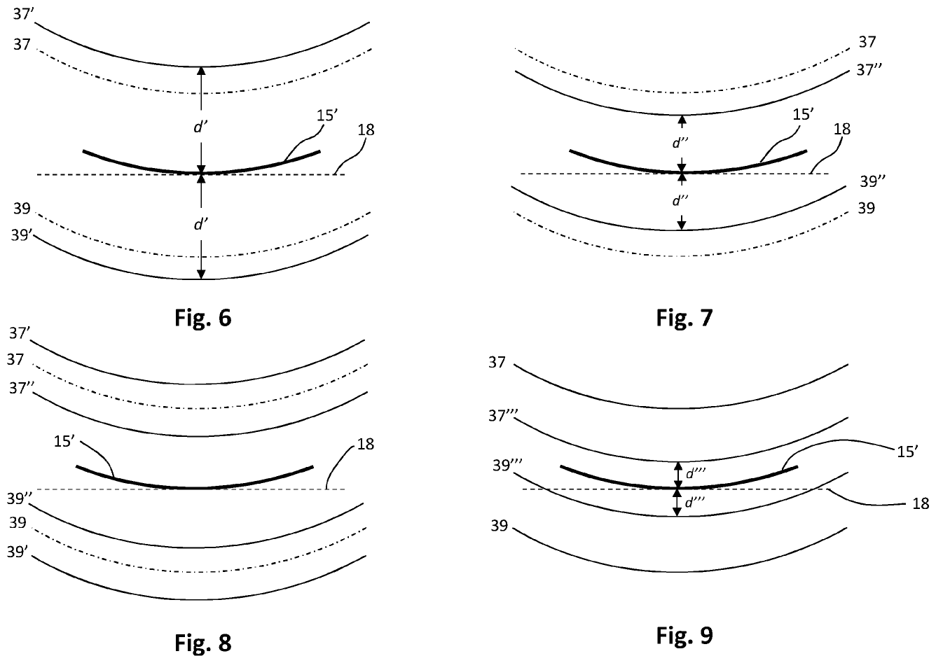

FIG. 6 is a schematic representation of the maximum quench surface separation for acceptable tempering;

FIG. 7 is a schematic representation of the minimum quench surface separation for acceptable tempering;

FIG. 8 summarises the maximum and minimum quench surface separation for acceptable tempering;

FIG. 9 illustrates the tolerance (or tempering) region for acceptable tempering of a glass sheet;

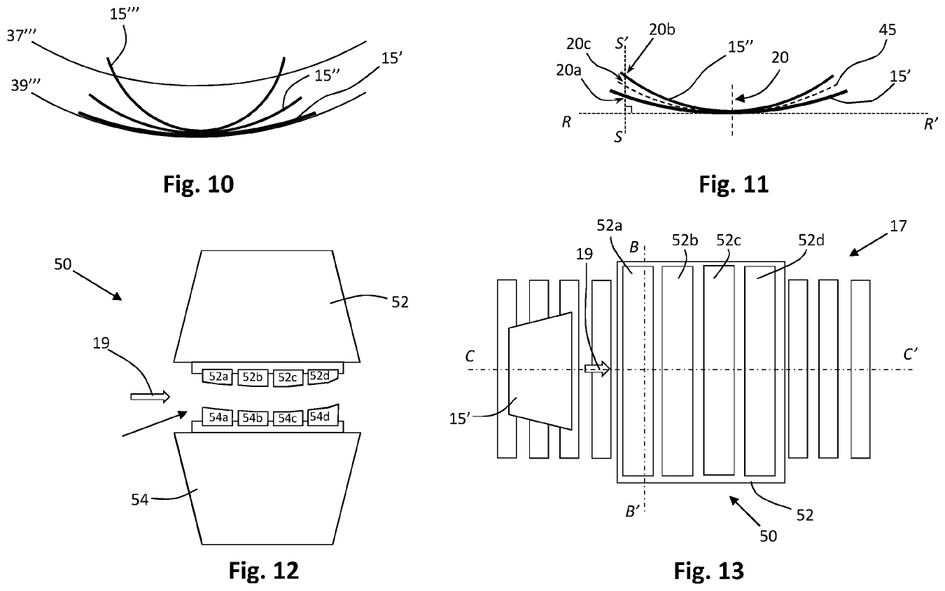

FIG. 10 shows the curvature of three glass sheets relative to the tolerance region for acceptable tempering;

FIG. 11 illustrates an average surface between two glasses to be tempered;

FIG. 12 shows a schematic side-view representation of a pair of blast heads having a modular construction;

FIG. 13 shows a schematic plan-view of the blastheads shown in FIG. 12;

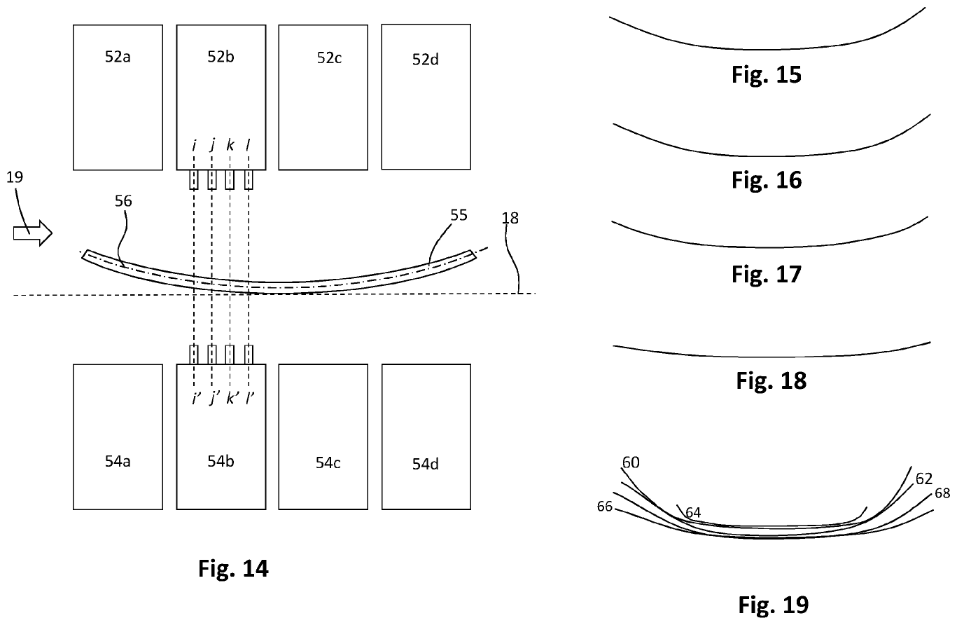

FIG. 14 shows a schematic side-view representation of upper and lower blastheads each having four quench modules;

FIGS. 15-18 illustrate the curvature of a glass sheet at different positions; and

FIG. 19 illustrates the curvature of five different glasses in one plane of one pair of quench modules.

With reference to FIGS. 1-3, FIG. 1 shows a schematic of a production line 1 for making a glazing panel. The production line comprises a heating furnace 3, a bending section 5, a tempering section 7 and a cooling section 9.

The production line 1 has a first axis 2 parallel to the direction of conveyance 19. The production line has a transverse axis 4 perpendicular to the first axis 2 of the production line. The first axis 2 runs in the longitudinal direction of the production line 1.

The production line 1 typically comprises conveying means 17 for conveying a plurality of glass sheets 15 through the heating furnace and the bending, tempering and cooling sections in a direction of conveyance indicated by arrows 19.

The conveying means is usually a conveyor roller bed comprising a plurality of elongate conveyor rollers to continuously convey the glass sheets 15 in the direction of arrows 19 along a plane of conveyance. Each elongate conveyor roller has a longitudinal axis that is perpendicular to the direction of conveyance (and hence in the direction of the longitudinal first axis 2 of the production line). The longitudinal axis of each elongate conveyor roller is essentially parallel to the second axis 4.

A plurality of glass sheets are individually loaded on and supported in a generally horizontal plane on the longitudinally spaced conveyor rolls. Each glass sheet is supplied to the conveyor roller bed by a supply conveyor 21. The supply conveyor may be configured to be parallel to the conveyor 17 or at an angle thereto, for example orthogonal. Any of a number of conventional aligning devices (not shown) can be used to align the glass sheets 15 for the trip through the furnace 3.

Other conveying means includes air flotation, and shuttle systems, and the conveying means may comprise a combination of one or more of conveyor rollers, air flotation or shuttle systems. The glass sheet may be in direct contact with the conveyor rollers or supported on a frame when being conveyed on the conveyor roller bed 17.

A glass sheet 15 is conveyed through the heating furnace and into the bending section 5 to bend the glass by a bending process. After leaving the bending section 5, the bent glass sheet 15′ is conveyed into the tempering section 7 to rapidly cool the glass to impart desired stress characteristics to the bent glass sheet. Examples of known tempering sections are described in WO00/23387A1 and WO2004/085326A1.

The bending section 5 may be part of the furnace 3 i.e. the bending process may take place inside the furnace 3.

The bent glass sheet 15′ is then conveyed through the cooling section 9 to cool the bent glass sheet to ambient temperature.

In the production line 1, the bending section 5 performs a processing step to bend the glass sheet. The tempering section 7 also performs a processing step to impart to the bent glass sheet suitable stress characteristics. The tempering section also performs a certain level of cooling of the glass sheet but typically not enough to cool the glass sheet to ambient conditions.

With reference to FIGS. 1, 2 and 3, the tempering section 7 comprises a quench box 30 comprising an upper blasthead 32 positioned above the plane of conveyance 18 and a lower blasthead 34 positioned below the plane conveyance 18. The plane of conveyance 18 is essentially a plane having tangential contact with the upper surface of the conveyor rollers.

The upper and lower blastheads 32, 34 comprise a number of rows of nozzles extending parallel to the second axis 4, for example as described in WO2004/085326A1.

A bent glass sheet 15′ to be tempered is shown positioned between the upper and lower blastheads 32, 34 with the lower major surface of the bent glass sheet on the conveyance plane 18. At this position the bent glass sheet can be suitably tempered, for example to meet the requirements of an international standard such as ECE R43.

Equally spaced between the upper and lower major surfaces of the bent glass sheet 15′ is an imaginary plane 16. The imaginary plane 16 is mid-way between the upper and lower surfaces of the bent glass sheet 15′ and parallel thereto. The imaginary plane 16 is on plane 18′ that is parallel to the plane of conveyance 18.

With reference to FIG. 4, which is a cross-sectional view through the line A-A′ of FIG. 3 i.e. looking down the length of the production line 1 in the direction of conveyance 19, the upper blast head 32 comprises a plurality of nozzles 33 arranged in a row extending parallel to the second axis 2. Each nozzle 33 has a respective exit end 33′ through which cooling fluid may issue.

The lower blast head 34 also comprises a plurality of nozzles 35 arranged in a row extending parallel to the second axis 2. Each nozzle 35 has a respective exit end 35′ through which cooling fluid may issue.

With reference to FIGS. 2, 4 and 5, the upper blast head 32 is designed such that the exit ends 33′ of the nozzles 33 lie in an upper quench surface 37 of the upper blast head. That is, the upper quench surface 37 of the upper blast head 32 is defined by the exit ends 33′ of the nozzles 33 in the upper blast head. For optimum tempering the upper quench surface 37 of the upper blast head 32 is parallel to the upper surface of the bent sheet of glass 15′. The upper quench surface 37 is also parallel to the plane 16 that is mid-way between the upper and lower surfaces of the bent glass sheet 15′.

Similarly, the lower blasthead 34 is designed such that the exit ends 35′ of the nozzles 35 lie in a lower quench surface 39 of the lower blast head. That is, the lower quench surface 39 of the lower blasthead 34 is defined by the exit ends 35′ of the nozzles 35 in the lower blast head. For optimum tempering the lower quench surface 39 of the lower blast head 34 is parallel to the lower surface of the bent sheet of glass 15′ and also the plane 16 that is mid-way between the upper and lower surfaces of the bent glass sheet 15′. Consequently, for optimum tempering the lower quench surface 39 is parallel to the upper quench surface 37.

The upper quench surface 37 is a first quench distance 41 away from the plane 16 that is mid-way between the upper and lower surfaces of the bent glass sheet 15′. The lower quench surface 39 is a second quench distance 43 away from the plane 16 that is mid-way between the upper and lower surfaces of the bent glass sheet 15′.

The position of the upper quench surface 37 may be specified relative to the upper or lower surface of the bent glass sheet 15′ Similarly, the position of the lower quench surface may be specified relative to the upper or lower surface of the bent glass sheet 15′. For example, the position of the upper quench surface may be a first quench distance away from the upper surface of the bent glass sheet and the position of the lower quench surface may be a second quench distance away from the lower surface of the bent glass sheet.

For a baseline condition, the first quench distance 41 is set to be the same as the second quench distance 43 (=d). It is evident that in the baseline condition, the plane 16 is tangential with the plane of conveyance. In the baseline condition the quench box 30 is configured to obtain the same heat transfer from both upper and lower surfaces of the bent glass sheet 15′ by adjusting the pressure of the cooling fluid to optimise the tempering operation. The operational parameters are then fixed for the baseline condition. A similar baseline condition may be determined for a different quench box design.

Whilst the baseline condition provides optimum tempering, it has been found possible to obtain acceptable tempering by positioning upper and lower quench surfaces 37, 39 at different positions relative to the bent glass sheet 15′ (and hence the plane 16 that is mid-way between the upper and lower surfaces of the bent glass sheet 15′) whilst keeping the other operational parameters fixed. Moving the quench surfaces relative to the bent glass sheet 15′ usually requires an adjustment of other parameters to optimise the tempering process, but having a non-optimised process provides other advantages as will be discussed hereinafter.

To determine the positional tolerance of the upper and lower quench surface 37, 39 all operational parameters used in the baseline condition are kept constant, and with a bent glass sheet 15′ at the same tempering position (i.e. as shown in FIG. 4) between the upper and lower blastheads, the separation of the upper and lower blastheads is changed. The bent glass sheet 15′ used to determine the positional tolerance has the same configuration (shape, thickness, composition etc) as the bent glass sheet used in the baseline condition.

After each change the effect on tempering performance is assessed relative to the baseline condition using a standard method such as defined in ECE R43.

The separation of the blastheads is varied until acceptable tempering is no longer achieved.

In FIG. 6 the separation of the upper and lower blastheads 32, 34 has been increased, which consequently increases the spacing of the upper and lower quench surfaces 37, 39 from the conveyance plane 18 (and the plane 16 that is mid-way between the upper and lower surfaces of the bent glass sheet 15′) . The original baseline positions of the upper and lower quench surfaces 37, 39 for optimum tempering are shown as dotted lines and the upper and lower quench surfaces in the new positions 37′, 39′ are shown as solid lines.

The distance of the plane 16 that is mid-way between the upper and lower surfaces of the bent glass sheet 15′ from the upper quench surface in the new position 37′ is d′. The distance of the plane 16 that is mid-way between the upper and lower surfaces of the bent glass sheet 15′ from the lower quench surface in the new position 39′ is also d′ (but may be different). It has been found that in the arrangement shown in FIG. 6, acceptable tempering may be achieved.

In FIG. 7 the separation of the upper and lower blastheads has been reduced such that the upper and lower quench surfaces 37, 39 are moved closer to the conveyance plane 18 (and the plane 16 that is mid-way between the upper and lower surfaces of the bent glass sheet 15′). The original baseline positions of the upper and lower quench surfaces 37, 39 for optimum tempering are shown as dotted lines and the upper and lower quench surfaces in the new positions 37″, 39″ are shown as solid lines.

The distance of the plane 16 that is mid-way between the upper and lower surfaces of the bent glass sheet 15′ from the upper quench surface in the new position 37″ is d″. The distance of the plane 16 that is mid-way between the upper and lower surfaces of the bent glass sheet 15′ from the lower quench surface in the new position 39″ is also d″ (but may be different). It has been found that in this arrangement, acceptable tempering may be achieved.

FIG. 8 is a summary of FIGS. 6 and 7 and shows the positions of the upper and lower quench surfaces that provide acceptable tempering relative to the optimum positions thereof. There is effectively a region where it is possible to temper the curved glass sheet 15′ to an acceptable level i.e. having the upper quench surface between quench surface 37′ and 37″ and the lower quench surface between quench surfaces 39′ and 39″.

A similar exercise was carried out as described above for a bent glass sheet having a different shape to the bent glass sheet 15′ with a corresponding quench box. Again, the limits were found for acceptable bending and found to be similar to the bent glass sheet 15′.

Carrying out numerous such analyses it was found that the allowable tolerance of the quench surfaces was essentially the same for a given nozzle arrangement and air flow therethrough.

Whilst the upper and lower quench surfaces may not be at the position for optimum, acceptable tempering is still possible by positioning the bent glass sheet within the determined positional tolerance band. That is, there is a tempering region where the tempered glass sheet is still able to be adequately tempered to meet the requirements of an international standard such as ECE R43.

This finding has been used by the present inventors in a method of designing a quench box in accordance with the present invention.

If a production line has three glass sheets to temper, each glass sheet having a different general shape, using a specially designed quench box as shown in FIG. 4 means that three pairs of upper and lower blastheads would need to be made in order to provide optimum tempering i.e. one pair of upper and lower blasthead for each different glass sheet to be tempered.

Using the above finding regarding there being a tempering region where the upper and lower quench surfaces may be positioned to obtain acceptable tempering, for certain glass shapes it is possible to have a single pair of blastheads that can be used to adequately temper all three glass sheets.

This is illustrated with reference to FIG. 9, where in relation to the conveyance plane 18 the position of the upper and lower quench surfaces 37, 39 is shown. The quench surfaces 37, 39 are as previously described and are the positions of the quench surfaces of the blastheads for optimum tempering.

In between the upper quench surface 37 and the conveyance plane 18 is surface 37′″ and in between the lower quench surface 39 and the conveyance plane 18 is surface 39″′.

The surface 37″′ is parallel to the upper surface of the bent glass sheet 15′ and the quench surface 37. The surface 39′″ is parallel to the lower surface of the bent glass sheet 15′ and the lower quench surface 39.

The spacing of the surfaces 37′″ and 39′″ is the same as the spacing of the quench surfaces 37′ and 37″ (and the spacing of quench surfaces 39′ and 39″) previously determined. The bent glass sheet 15′ is equidistant (at distance d″) between the surfaces 37′″ and 39′″. As can be readily seen, the distance d″′ =(d′−d′)/2 and the plane 16 now lies on the conveyance plane 18 making tangential contact therewith.

The present inventors have found that for a given positional tolerance region from the optimum tempering as defined by surfaces 37′″ and 39″′ , glass sheets having different shapes may be adequately tempered between the upper and lower blastheads. This is illustrated with the aid of FIG. 10 where three different bent glass sheets 15′, 15″ and 15″′ are shown each having a different degree of curvature (and hence a different shape). Although the bent glass sheet 15″ is more curved than the bent glass sheet 15′, the curvature thereof still lies within the bounds of surfaces 37″′ and 39′″, which indicates that the same pair of upper and lower blastheads may be used to temper both bent glass sheets 15′ and 15″. Or put another way, the maximum deviation of the curvature of the bent glass sheet 15″ relative to the bent glass sheet 15′ is less than the spacing between the surfaces 37″′ and 39′″ (=2×d″′).

The maximum deviation of the curvature of the third glass sheet 15″′ is greater than the spacing of the surfaces 37″′ , 39′″ so cannot be adequately tempered by the same quench box that is used to temper the bent glass sheets 15′ and 15″. As can be seen, the maximum deviation of the curvature of the bent glass sheet 15″′ relative to the bent glass sheet 15′ is more than the spacing between the surfaces 37″′ and 39′″ (=2×d″′) because the bent glass sheet 15″′ is outside of the bounds defined by surfaces 37′″ and 39″′.

Whilst the bent glass sheets 15′ and 15″ may both be tempered between the upper and lower blastheads 32, 34 having upper and lower quench surfaces 37, 39 the present invention determines average upper and lower quench surfaces required for the tempering process for different glass sheets having different shapes.

In the example illustrated by FIG. 10, the third bent glass sheet 15″′ to be tempered has a different shape to the first and second bent glass sheets 15′, 15″ that partly falls outside the space between the surfaces 37″′ and 39″′ , so requires a different pair of quench surface to be adequately tempered.

To help better optimise the tempering of the first and second bent glass sheets 15′, 15″, an approximate upper and lower quench surface is determined based on the average curvature of the first and second glass sheets 15′, 15″. This is illustrated schematically in FIG. 11 where the dotted line 45 approximates the two lines 15′, 15″ which represent the curvature of the glass sheets in that plane, see FIGS. 4 and 5.

The dotted line 45 was determined as follows. The curves being analysed (in this case 15′ and 15″) are positioned on a horizonal plane R-R′ with the respective centrelines thereof aligned, as indicated by line 20. Each curve 15′ and 15″ is symmetrical about the respective centreline thereof. Next, a vertical line S-S′ spaced apart from line 20 is projected upwards from the horizontal plane R-R′ to intersect the curves being analysed. The vertical line S-S′ is normal to the plane R-R′ . In the example shown in FIG. 11, the vertical line S-S′ intersects the curve 15′ at point 20a and intersects the curve 15″ at the point 20b. For example, the point 20a is q units away from the horizonal plane R-R′ and the point 20b is r units away from the horizonal plane R-R′. The point 20c is (q+r)/2 units away from the horizonal plane R-R′ i.e. the arithmetic average. The line S-S′ is moved away from the centrelines 20 (i.e. left and right as shown in FIG. 11) to determine the shape of the line 45. The shape of the line 45 may be determined at selected points only spaced from the centrelines 20.

If there are more curves being analysed (because more curves lie within the positional tolerance band), the same procedure is used as outlined above except the point 20c will be at an average position of all the intersection points. For example, if a third curve being analysed intersects the line S-S′ at point 20d and the point 20d was s units away from the horizontal plane R-R, then the point 20c will be (q+r+s)/3 units away from the horizonal plane R-R′.

The point 20c may be determined by other methods, such as being a geometric average or a least squares fit. The aim is to determine a line that approximates all the lines being analysed in a particular plane, thereby finding an average surface that approximates all the glass shapes.

Similar approximate curves may be determined in different parallel planes. An upper blasthead may be designed having an average upper quench surface 45 as shown. Similarly, a lower blasthead may be designed having an average lower quench surface (which will be parallel to the average quench surface 45).

As is evident from FIGS. 4-11, the average upper quench surface 45 provides the surface in which the exit ends 33′ of the nozzles 33 lie. For all such rows of nozzles in the upper blasthead a respective average upper quench surface may be determined (and similarly for the nozzles 35 of the lower blasthead 34).

The resulting average upper and lower quench surfaces will adequately temper both bent glass sheets 15′ and 15″.

It may be advantageous to divide the array of nozzles of the upper and lower blastheads into multiple quench modules. In this way, using a similar approach as described above, the average upper and lower quench surfaces of pairs of quench modules may be determined. A repository of previously designed quench modules may be built up, allowing previously designed quench modules to be re-used.

An example of a quench box having pairs of upper and lower quench modules is shown in FIGS. 12 and 13.

In FIG. 12 there is shown a quench box 50 having an upper blasthead 52 and a lower blasthead 54. The upper blasthead 52 comprises four upper quench modules 52a, 52b, 52c and 52d. The lower blasthead 54 comprises four lower quench modules 54a, 54b, 54c and 54d.

The quench modules are paired such that opposing pairs 52a/54a, 52b/54b, 52c/54c and 52d/54d are configured to direct cooling air towards opposing surfaces of the same respective portion of the glass sheet to be tempered. In this example, there are four pairs of quench modules. The upper and lower quench surfaces of each pair of upper and lower quench module is preferably vertically aligned. There may be more or less than four pairs of quench modules.

A plan view of the quench box 50 is shown in FIG. 13. As can be seen in FIG. 13, the quench modules 52a, 52b, 52c, 52d of the upper blasthead 52 extend across the roller conveyor 17 i.e. perpendicular to the direction of conveyance 19 and parallel to the second axis 4

FIG. 12 is a schematic cross-sectional view along the centreline C-C′, which is parallel to the direction of conveyance 19. A view along the line B-B′ of FIG. 13 is essentially the same as shown in FIG. 4.

In contrast to the quench box shown in FIG. 4, the quench box 50 comprises four spaced apart pairs of upper and lower quench modules. Each pair of upper and lower quench modules have a quench surface that approximately follows the contour of the glass sheet to be tempered in a certain part of the glass sheet. The shape of the quench surfaces is determined in accordance with the present invention and as described with reference to FIGS. 6-11.

In one example, each pair of quench modules of the upper/lower blasthead 52ₙ/54ₙ comprises eight rows of nozzles extending in a line perpendicular to the direction of conveyance 19 i.e. as shown in FIG. 4. For each row of nozzles, the quench surface thereof is determined as shown in relation to FIGS. 10 and 11. The quench surface of each quench module is an average quench surface based on the analysis of the different glasses to be tempered and approximates the shape of all the glasses to be adequately tempered by that particular set of quench modules.

The following example is provided based on a quench box as previously described having four pairs of upper and lower quench modules. In this example each quench module has four rows of nozzles that extend perpendicular to the direction of conveyance i.e. in this example the glass surface is divided into sixteen sections extending perpendicular to the direction of conveyance. Each section may be uniformly spaced from other sections, or there may be more or less than sixteen sections, for example each quench module may have eight or more rows of nozzles.

The glasses to be tempered by a production line are analysed with an aim to determine the least number of pairs of quench modules to adequately temper the glasses. In this example the glass sheets are of a generally trapezoidal shape of the type used in a vehicle windscreen, and are all to be conveyed through the production line with the long edge leading, as shown in FIGS. 3 and 13. Each glass sheet essentially has a line of symmetry about a respective centreline therefore and the glass sheets are transported through the production line with the centreline of the glasses being parallel, or substantially parallel, to the direction of conveyance 19.

Each glass sheet is divided into a number of curves to represent the curved glass surface thereof. The curves for each glass sheet are obtained by intersecting the plane of each row of nozzles of the upper blasthead with the plane mid-way between the upper and lower surfaces of the respective glass sheet, with the centreline of each glass sheet being aligned, as previously described. The shape of each glass sheet is thus reduced into sixteen curves, four for each quench module. This is illustrated in FIG. 14 for the pair of upper and quench modules 52b/54b and a glass sheet to be tempered 55. The glass sheet 55 has an imaginary plane 56 mid-way between the upper and lower major surfaces thereof. The imaginary plane 56 is parallel to the upper and lower major surfaces of the glass sheet 55 and the glass sheet 55 may be positioned on the plane of conveyance 18 such that the distance between the upper surface of the glass sheet 55 and the upper quench surface is the same as the distance between the lower surface of the glass sheet and the lower quench surface.

FIG. 15 is the curve obtained by intersecting imaginary plane 56 of the glass sheet 55 with the plane i-i′. FIG. 16 is the curve obtained by intersecting the imaginary plane 56 of the glass sheet 55 with the plane j-j′. FIG. 17 is the curve obtained by intersecting imaginary plane 56 of the glass sheet 55 with the plane k-k′. FIG. 18 is the curve obtained by intersecting the imaginary plane 56 of the glass sheet 55 with the plane 1-1′. There will be similar curves obtained for each pair of quench modules 52a/54a, 52b/54b, 52c/54c and 52d/54d to fully describe the shape of the glass sheet 55. Sets of curves are obtained for each glass sheet to be tempered.

The procedure essentially as outlined above with reference to FIGS. 10 and 11 is then used to determine the shape of the quench surfaces for each pair of quench modules. That is, for the glasses to be tempered an average quench surface is determined that approximates the shape of all the glasses to be adequately tempered and that have a curvature that lie with the positional tolerance band or where there is less than the positional tolerance deviation between the glass shapes.

FIG. 19 shows the curves obtained for five different glasses to be tempered along the plane i-i′ of FIG. 14. As was discussed above with reference to FIGS. 4 to 11, for a given glass shape the quench surfaces used to temper the glass sheet may be positioned in a range either side of the glass sheet. The spacing of the surfaces from the optimum position of the quench surface may be determined (shown as d″′ in FIG. 9) and this spacing has been found to be essentially the same for difference shapes of glass sheets. Consequently, if the deviation between the curvature of two glass sheets in the plane of a row of nozzles differs by more than 2×d″′ then the same pair of quench surfaces may not be used to adequately temper both glasses.

With reference to FIG. 19, it was found that the maximum difference between three of the curves 64, 66, 68 is less than 2×d″′, so these three glasses (referenced hereinafter as 64′, 66′ and 68′) can be adequately tempered with the same row of nozzles in the upper and lower pair of quench modules.

The maximum deviation between pairs of curves 66 and 60 and 66 and 62 is more than 2×d″′ so these two glasses (referenced hereinafter as 60′ and 62′) cannot be adequately tempered by the same row of nozzles in the upper and lower pair of quench modules as may be used to adequately temper the glasses 64′, 66′ and 68′.

The maximum deviation between the two curves 60 and 62 is less than 2×d″′, so the same row of nozzles in the upper and lower pair of quench modules may be used to adequately temper the two glasses 60′ and 62′ in this region.

The above is carried out for each row of nozzles for each pair of quench modules. With reference to FIG. 14, this exercise is illustrated for the pairs of quench modules 52b, 54b having planes i-i′, j-j′, k-k′ and l-l′ defined by opposing rows of nozzles in the upper and lower quench modules 52b, 54b.

If for each plane i-i′, j-j′, k-k′ and l-l′ in a pair of quench modules the group of glasses fall within the maximum allowable deviation of 2×d″′ (as discussed above for the plane i-i′ of the pair of quench modules 52b, 54b), then that pair of quench modules can be used to adequately temper that group of glasses.

With reference to the above, it was found that a pair of quench modules with respective upper and lower quench surface can adequately temper the glasses 64′, 66′ and 68′ and another pair of quench modules can be used to adequately temper the glasses 60′ and 62′.

The same exercise was carried out for each pair of quench modules to arrive at the minimum number of pairs of quench modules that may be used to adequately temper all five glasses.

To illustrate the final analysis of the five different curved glass sheets, as discussed above each glass sheet was divided into four regions (A0, B0, C0, D0), one region for each pair of quench modules 52a/54a, 52b/54b, 52c/54c and 52d/54d.

It was possible to arrive at a single quench surface (A1) in region a that was within tolerance for all five curved glass sheets. For region b′ two quench surfaces (B1, B2) were calculated to be within tolerance for all five curved glass sheets. For region c′ three quench surfaces (C1, C2, C3) were calculated to be within tolerance for all five curved glass sheets. For region d′ four quench surfaces (D1, D2, D3, D4) were calculated to be within tolerance for all five curved glass sheets.

This is illustrated in the table 1 below.

TABLE 1

| | Curved Glass Sheet Number: | | | | |
|---|---|---|---|---|---|
| Region | 1 | 2 | 3 | 4 | 5 |
| A0 | A1 | A1 | A1 | A1 | A1 |
| B0 | B1 | B2 | B2 | B2 | B2 |
| C0 | C1 | C2 | C2 | C2 | C3 |
| D0 | D1 | D2 | D2 | D3 | D4 |

The above table 1 shows that for region A0, all five glasses could be suitably tempered in region AO with a single pair of quench modules having average quench surfaces A1.

For glass 1, an approximate upper and lower quench surface to adequately temper the curved glass sheet 1 can be made by using pairs of quench box modules A1, B1, C1 and D1. Likewise, an approximate upper and lower quench surface to adequately temper the curved glass sheet 2 can be made by using pairs of quench modules A1, B2, C2 and D2. The other approximate upper and lower quench surfaces for the glasses 3-5 is provided in table 1.

The approximate quench surface is determined by analysing the groups of glasses that may be adequately tempered in each region and calculating an average quench surface therefrom, for example as described with reference to the glasses 15′ and 15″ of FIG. 11.

With reference to the example shown in table 1 above, the curvature of the glasses used to determine the average quench surface of each quench module is as shown in table 2.

Once the average quench surface of each pair of upper and lower quench modules has been determined using the above approach, the quench modules may be made by positioning the exits ends of the nozzles accordingly.

TABLE 2

| Average Quench Region | Glass used for average quench surface |
|---|---|
| A1 | 1, 2, 3, 4, 5 |
| B1 | 1 |
| B2 | 2, 3, 4, 5 |
| C1 | 1 |
| C2 | 2, 3, 4 |
| C3 | 5 |
| D1 | 1 |
| D2 | 2, 3 |
| D3 | 4 |
| D4 | 5 |

A final check may be carried out once the quench modules have been designed to ensure the average quench surface lies with the positional tolerance range for acceptable tempering, see FIG. 9. For a given tempering operation, the upper and lower quench surfaces are spaced apart by a distance 2×d, see FIG. 5. For a given glass to be tempered between an arrangement of quench modules determined according to the above, the surface of the glass sheet is compared to the average quench surface.

For example, in table 1 glass number 1 can be adequately tempered using pairs of quench modules having the average quench surface A1:B1:C1:D1.

By reducing the glass number 1 to a number of curves as described with reference to FIG. 14, the distance from each curve and the upper and lower quench surfaces can be calculated. It is required for each such curve representing the glass to be tempered that the minimum distance from each curve to the upper average quench surface is between d+d″′ and d−d″′. The maximum distance from each curve to the lower average quench surface is between d+d′″ and d−d″′.

If the above criteria are met for each curve representing the glass surface, the quench box design will adequately temper the particular group of glasses.

Actual values of d and d″′ for a particular pair of blastheads may be determined as discussed above and in relation to FIGS. 5-9.

A suitable framework may be constructed to accommodate the quench modules and the same framework may be used for each combination of quench modules. This helps reduce costs.

In the above example, if a separate pair of blastheads was designed for each curved glass sheet to be tempered, there would be five pairs of upper and lower blastheads.

By designing the quench box in accordance with the present invention, ten pairs of upper and lower quench modules were made that are able to fit into a single framework for the upper and lower blastheads, thereby reducing manufacturing costs. Furthermore, the quench modules may be stored for later use, and being less bulky than a complete blasthead, storage is simpler and requires less space.

It is therefore possible to analyse the glass shapes that are planned to be made to arrive at a number of quench modules that can be assembled to approximate the quench surface that would be made using a conventional unitary quench box.

Although in the previous examples pairs of upper and lower quench modules were designed, it is also within the scope of the present invention to have a single quench module in the one of the blastheads and two or more quench modules in the other blasthead, the single quench module preferably having an average quench surface of one of the major surfaces of the group of glasses to be tempered.

Also, although in the example above the glass sheets were conveyed through the furnace with the long edge leading, the present invention may be used for glass sheets that are conveyed with the short edge leading. The present invention may be used to design apparatus for tempering glass sheets having any shape major surface in plan elevation being conveyed through the production line, provided the desired level of tempering is achieved in the glass sheets.

The present invention is particularly useful for reducing the number of blastheads that may be required to temper different groups (or families) of glasses.

1. A method for designing a quench box for tempering at least first, second and third sheets of glass each having a different shape,
the quench box comprising a first blasthead and a second blasthead spaced apart therefrom, the first blasthead being opposite the second blasthead and each of the first and second blastheads being configured to direct jets of cooling fluid towards a conveyance plane for conveying a sheet of glass thereon, the conveyance plane having a first axis and a second axis, the first axis defining a direction of conveyance for a glass sheet along the conveyance plane and the second axis being perpendicular to first axis;
the quench box having a first configuration for tempering the first and second sheets of glass and a second different configuration for tempering the third sheet of glass;
wherein in the first configuration, the first blasthead of the quench box comprises at least a first quench module and a second quench module, and the second blasthead of the quench box comprises at least a first quench module, each quench module comprising a respective array of quench nozzles defining a respective quench surface;
further wherein when the quench box is in the second configuration, at least one of the quench modules of the first and second blastheads has been replaced with a different quench module, the or each different quench module comprising a respective array of quench nozzles defining a respective quench surface;
the method comprising:
(i) using the shape of at least the first and second sheets of glass to calculate a first average surface, the first average surface being an approximation of the shape of the at least first and second sheets of glass;
(ii) using the first average surface to calculate the respective quench surface of the first and second quench modules of the first blasthead so that in the first configuration the first and second quench modules of the first blasthead are arranged so that the quench surfaces thereof are at least partially alignable with at least a portion of the first average surface;
(iii) using the first average surface to calculate the quench surface of the first quench module of the second blasthead so that in the first configuration the first quench module of the second blasthead is arranged so that the quench surface thereof is at least a partially alignable with at least a portion of the first average surface;
and
(iv) using the shape of at least the third sheet of glass to calculate the quench surface of the or each different quench module, so that that in the second configuration the quench modules of the first and second blastheads are arranged so that the quench surfaces thereof approximate the shape of the third sheet of glass.

2. A method according to claim 1, wherein the first average surface comprises a geometric average or an arithmetic average or a weighted average or a least squares fit of the shapes of the at least first and second sheets of glass.

3. A method according to claim 1, wherein the first average surface is calculated by (a) determining for each of the at least first and second sheets of glass a plane mid-way between opposing major surfaces of each respective glass sheet, each plane having a centreline arranged to be parallel to the first axis; (b) arranging each plane determined in (a) such that the centrelines thereof are coincident and lie on a horizontal plane; (c) for a given point on the horizontal plane, extending a line normal to the horizontal plane through the given point to intersect each plane of the at least first and second sheets of glass at a respective intersection point;
and (d) using each intersection point to determine an average intersection point for the at least first and second sheets of glass at the given point, the average intersection point being a first average distance from the horizontal plane.

4. A method according to claim 1, wherein when the quench box is in the second configuration, at least one of the first and second quench modules of the first blasthead is replaced by a different quench module, the or each different quench module comprising a respective array of quench nozzles defining a quench surface.

5. A method according to claim 1, wherein when the quench box is in the second configuration, the first quench module of the second blasthead is replaced by a different quench module, the different quench module comprising a respective array of quench nozzles defining a quench surface.

6. A method according to claim 1, wherein the second blasthead comprises a second quench module comprising a respective array of quench nozzles defining a quench surface, and wherein the method includes using the first average surface to calculate the quench surface of the second quench module of the second blasthead so that in the first configuration the first and second quench modules of the second blasthead are arranged so that the quench surfaces thereof are at least partially alignable with at least a portion of the first average surface.

7. A method according to claim 6, wherein when the quench box is in the second configuration, at least one of the first and second quench modules of the first blasthead has been replaced by a respective different quench module, the or each different quench module comprising a respective array of quench nozzles defining a quench surface; or wherein when the quench box is in the second configuration, at least one of the first and second quench modules of the second blasthead has been replaced by a respective different quench module, the or each different quench module comprising a respective array of quench nozzles defining a quench surface.

8. (canceled)

9. A method according to claim 6, wherein the quench surface of the first quench module of the first blast head is parallel to the quench surface of the first quench module of the second blasthead and/or wherein the quench surface of the second quench module of the first blast head is parallel to the quench surface of the second quench module of the second blasthead.

10. (canceled)

11. A method according to claim 6, wherein the first blasthead comprises a third quench module comprising a respective array of quench nozzles defining a quench surface, and the method incudes using the first average surface to calculate the quench surface of the third quench module of the first blasthead, so that in the first configuration the first, second and third quench modules of the first blasthead are arranged so that the quench surfaces thereof are at least partially alignable with at least a portion of the first average surface.

12. A method according to claim 11, wherein when the quench box is in the second configuration, at least one of the first, second and third quench modules of the first blasthead has been replaced by a respective different quench module, the or each different quench module comprising a respective array of quench nozzles defining a quench surface; and/or wherein when the quench box is in the second configuration at least one of the first and second quench modules of the second blasthead has been replaced by a respective different quench module, the or each different quench module comprising a respective array of quench nozzles defining a quench surface.

13. (canceled)

14. A method according to claim 6, wherein the second blasthead comprises a third quench module comprising a respective array of quench nozzles defining a quench surface, and wherein the method includes using the first average surface to calculate the quench surface of the third quench module of the second blasthead so that in the first configuration the first, second and third quench modules of the second blasthead are arranged so that the quench surfaces thereof are at least partially alignable with at least a portion of the first average surface.

15. A method according to claim 14, wherein when the quench box is in the second configuration, at least one of the quench modules of the first blasthead or at least one of the quench modules of the second blasthead is replaced by a different quench module, the or each different quench module comprising a respective array of quench nozzles defining a quench surface.

16. A method according to claim 11, wherein the first blasthead comprises a fourth quench module comprising a respective array of quench nozzles defining a quench surface, and wherein the method includes using the first average surface to calculate the quench surface of the fourth quench module of the first blasthead so that in the first configuration the first, second, third and fourth quench modules of the first blasthead are arranged so that the quench surfaces thereof are at least partially alignable with at least a portion of the first average surface.

17. A method according to claim 16, wherein when the quench box is in the second configuration, at least one of the quench modules of the first blasthead or at least one of the quench modules of the second blasthead is replaced by a different quench module, the or each different quench module comprising a respective array of quench nozzles defining a quench surface.

18. A method according to claim 14, wherein the second blasthead comprises a fourth quench module comprising a respective array of quench nozzles defining a quench surface, and wherein the method includes using the first average surface to calculate the quench surface of the fourth quench module of the second blasthead so that in the first configuration the first, second, third and fourth quench modules of the second blasthead are arranged so that the quench surfaces thereof are at least partially alignable with at least a portion of the first average surface.

19. A method according to claim 18, wherein when the quench box is in the second configuration, at least one of the quench modules of the first blasthead or at least one of the quench modules of the second blasthead is replaced by a different quench module, the or each different quench module comprising a respective array of quench nozzles defining a quench surface.

20. A method according to any claim 1, wherein the first quench module of the first blasthead comprises two or more nozzles arranged in a line running parallel to the first axis or the second axis; or wherein the first quench module of the first blasthead comprises two or more rows of nozzles running parallel to the first axis or the second axis.

21. (canceled)

22. A method according to claim 1, wherein the first quench module of the second blasthead comprises two or more nozzles arranged in a line running parallel to the first axis or the second axis; or wherein the first quench module of the second blasthead comprises two or more rows of nozzles running parallel to the first axis or the second axis.

23. (canceled)

24. (canceled)

25. (canceled)

26. A method according to claim 1, wherein in the using of the shape of at least the third sheet of glass to calculate the quench surface of the or each different quench module, the shape of the third sheet of glass and at least one other sheet of glass having a different shape are used to calculate a second average surface, the second average surface being an approximation of the shape of the third sheet of glass and the at least one other sheets of glass; and wherein the second average surface is used to calculate the quench surface of the or each different quench module, so that that in the second configuration the quench modules are arranged so that the quench surfaces thereof are at least partially alignable with at least a portion of the second average surface.

27. A method for tempering at least first, second and third sheets of glass each having a different shape with a quench box,
the first and second sheets of glass having a first average surface, the first average surface being an approximation of the shape of the first and second sheets of glass;
the quench box comprising a first blasthead and a second blasthead spaced apart therefrom, the first blasthead being opposite the second blasthead and each of the first and second blastheads being configured to direct jets of cooling fluid towards a conveyance plane for conveying a sheet of glass thereon, the conveyance plane having a first axis and a second axis, the first axis defining a direction of conveyance for a glass sheet along the conveyance plane and the second axis being perpendicular to first axis;
the quench box having a first configuration for tempering the first and second sheets of glass and a second different configuration for tempering the third sheet of glass;
wherein in the first configuration, the first blasthead of the quench box comprises at least a first quench module and a second quench module, and the second blasthead of the quench box comprises at least a first quench module, each quench module comprising a respective array of quench nozzles defining a respective quench surface;
wherein in the first configuration the first and second quench modules of the first blasthead are arranged so that the quench surfaces thereof are at least partially alignable with at least a portion of the first average surface, and
wherein the first quench module of the second blasthead is arranged so that the quench surface thereof is at least a partially alignable with at least a portion of the first average surface;
further wherein when the quench box is in the second configuration, at least one of the quench modules of the first and second blastheads has been replaced with a different quench module, the or each different quench module comprising a respective array of quench nozzles defining a respective quench surface,
wherein in the second configuration the quench modules of the first and second blastheads are arranged so that the quench surfaces thereof approximate the shape of the third sheet of glass.
